(19) United States
(12) Patent Application Publication
(10) Pub. No.: US 2019/0283934 A1
(43) Pub. Date: Sep. 19, 2019

(54) INFORMATION ACQUISITION SYSTEM, MANAGEMENT SYSTEM, SHOPPING ASSISTANCE SYSTEM, INFORMATION ACQUISITION METHOD AND NON-TRANSITORY COMPUTER-READABLE MEDIUM

(71) Applicant: Panasonic Intellectual Property Management Co., Ltd., Osaka (JP)

(72) Inventors: Tatsuaki AMEMURA, Tokyo (JP); Ryusuke KAWAMOTO, Osaka (JP); Yuki URATA, Osaka (JP); Manabu EGUCHI, Hyogo (JP); Hiroyuki KODA, Osaka (JP)

(21) Appl. No.: 16/351,854

(22) Filed: Mar. 13, 2019

(30) Foreign Application Priority Data
Mar. 19, 2018 (JP) 2018-051684
Mar. 19, 2018 (JP) 2018-051686

(51) Int. Cl. B65D 21/02; H04W 4/33; B65D 1/38; B65D 25/20

(52) U.S. Cl. CPC B65D 21/0233; B65D 25/20; B65D 1/38; H04W 4/33

(57) ABSTRACT

An information acquisition system includes a transport device, a communication unit and a receiver. The transport device allows one or more articles to be put on or in and is used for transportation of the one or more articles in a facility. The communication unit is configured to communicate with the transport device. The receiver is configured to acquire state information from the transport device through communication between the communication unit and the transport device. The state information is information on a state of the transport device.

### CROSS REFERENCE TO RELATED APPLICATION

This application claims the benefit and priority of Japanese Patent Application No. 2018-51684 filed on Mar. 19, 2018, and Japanese Patent Application No. 2018-51686 filed on Mar. 19, 2018, the entire contents of which is incorporated herein by reference.

### TECHNICAL FIELD

The present disclosure relates generally to information acquisition systems, management systems, shopping assistance systems, information acquisition methods and non-transitory computer-readable media. The disclosure relates, more particularly, to an information acquisition system, a management system, a shopping assistance system, an information acquisition method and a non-transitory computer-readable medium, for a facility (or premises) into which (a) transport (or carrier) devices that allow(s) one or more articles to be put on or in are(is) introduced.

### BACKGROUND ART

Document 1 (JPH04-58113U) describes a shopping basket used for shopping at supermarkets and the like. The shopping basket is equipped with a bar code reader. This shopping basket functions as a transport device that allows goods, as a target object to be carried, to be put in and that is used for transportation thereof.

The shopping basket described in Document 1 is configured to cause the bar code reader to read barcodes carried by goods to calculate amount of the goods to be displayed on a display. This configuration enables customers to finish the checkout by paying the amount displayed on the display at a register or the like.

A store manager (administrator) of a store into which the shopping baskets described in Document 1 are introduced is able to grasp information (amount of money) on goods (articles) as a checkout target. There is however an issue that the administrator cannot grasp information on each shopping basket (transport device).

### SUMMARY

The disclosure relates to an information acquisition system, a management system, a shopping assistance system, an information acquisition method and a non-transitory computer-readable medium, enabling an administrator to grasp information on a transport device.

An information acquisition system according to an aspect of the disclosure includes a transport device, a communication unit, and a receiver (acquisition unit). The transport device allows one or more articles to be put on or in and is used for transportation of the one or more articles in a facility. The communication unit is configured to communicate with the transport device. The receiver is configured to acquire (receive) state information from the transport device through communication between the communication unit and the transport device. The state information is information on a state of the transport device.

A shopping assistance system according to an aspect of the disclosure includes the information acquisition system and a selling system. The selling system is configured to perform a selling process of the one or more articles as one or more goods.

An information acquisition method according to an aspect of the disclosure includes acquiring state information from a transport device through communication with the transport device. The transport device allows one or more articles to be put on or in and is used for transportation of the one or more articles in a facility. The state information is information on a state of the transport device.

A non-transitory computer-readable medium according to an aspect of the disclosure stores a program comprising instructions which, when executed on a computer system, perform acquiring state information from a transport device through communication with the transport device. The transport device allows one or more articles to be put on or in and is used for transportation of the one or more articles in a facility. The state information is information on a state of the transport device.

### BRIEF DESCRIPTION OF THE DRAWINGS

FIG. 1 is a schematic block diagram showing respective configurations of an information acquisition system and a shopping assistance system, in accordance with an embodiment of the present disclosure.

FIG. 2 is a schematic block diagram showing respective configurations of the information acquisition system, a main management system and the shopping assistance system.

FIG. 3 is a schematic block diagram showing a configuration of a shopping basket used for the information acquisition system.

FIG. 4 is an exterior perspective view of the shopping basket.

FIG. 5 is an exterior perspective view of shopping baskets stacked on a power supply device in the shopping assistance system.

FIG. 6 is a sequence diagram showing an operation of the information acquisition system.

FIG. 7 is a flowchart showing an operation of a shopping basket in a second acquisition example by the information acquisition system.

FIG. 8 is a store plan view showing an example of customer flow line in the second acquisition example by the information acquisition system.

FIG. 9 is a graph showing an example of respective pieces of information on shopping baskets managed by the main management system.

### DETAILED DESCRIPTION

### (1) Schema

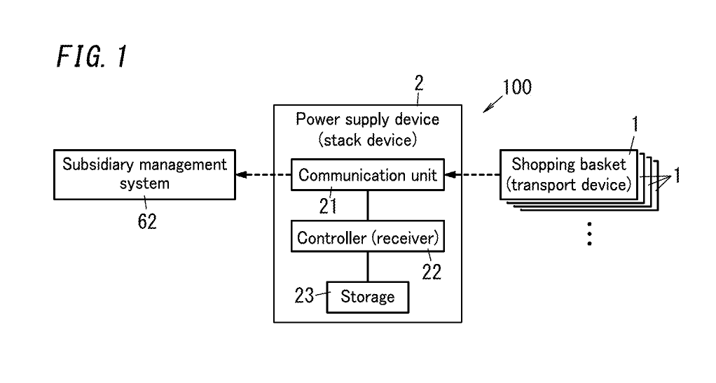

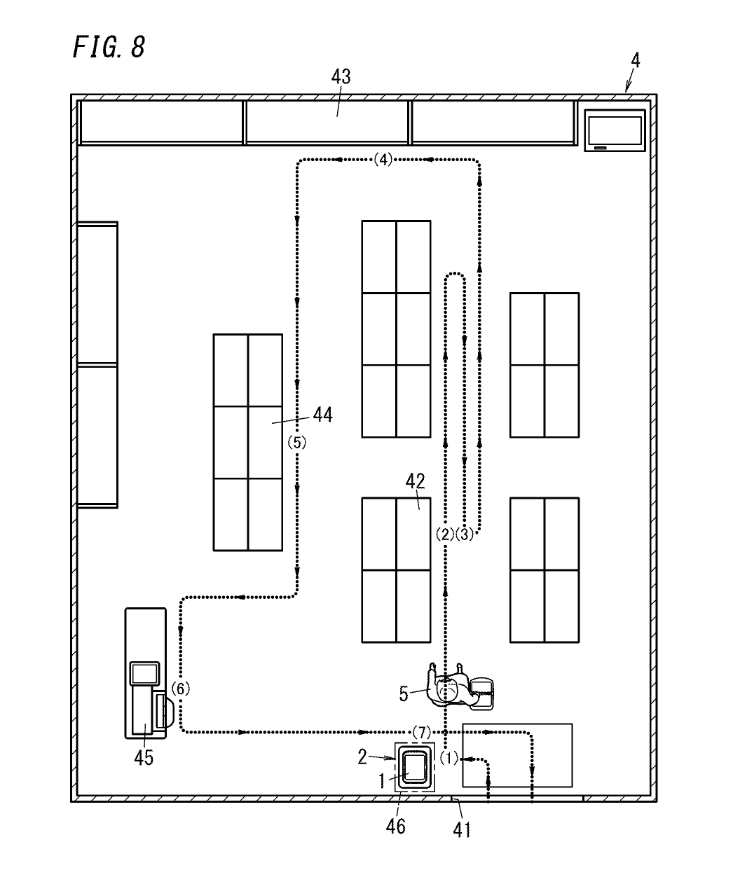

The schema of an information acquisition system 100 according to the present embodiment will first be explained with reference to FIGS. 1 to 3. The information acquisition system 100 according to the embodiment is configured to acquire state information on a transport device 1. The “transport device” stated in the present disclosure is used for transportation of (for carrying and transferring) one or more articles in a facility (or premises) 4 (see FIG. 8), and allows the one or more articles to be moved together with the transport device 1 with the one or more articles held. Specifically, examples of the transport device 1 include: containers such as baskets and tableware, each of which allows one or more articles to be put in, thereby holding the one or more articles; and carts, trays, dishes, hand trucks and the like, each of which allows one or more articles to be put on, thereby holding the one or more articles. In addition, the “state information” stated in the disclosure is information on a state of the transport device 1. That is, the “state information” is not information on a state of the one or more articles put on or in the transport device 1, but information on a state of the transport device 1 itself.

In an example to be explained in the present embodiment, each transport device 1 is a shopping basket. Unless otherwise specified, the transport device 1 is also referred to as a “shopping basket 1”. The shopping basket 1 is used in a store 4, and examples thereof include retail stores such as convenience stores, supermarkets, department stores, drugstores, electronics retail stores, and home centers. This kind of shopping basket 1 is used for transportation of goods as articles sold in the store 4. Unless otherwise specified, one or more articles are also referred to as “one or more goods”. In addition, unless otherwise specified, respective one or more pieces of article information on one or more articles (goods) are referred to as respective “one or more pieces of goods (or product) information”, while the facility is referred to as the “store”.

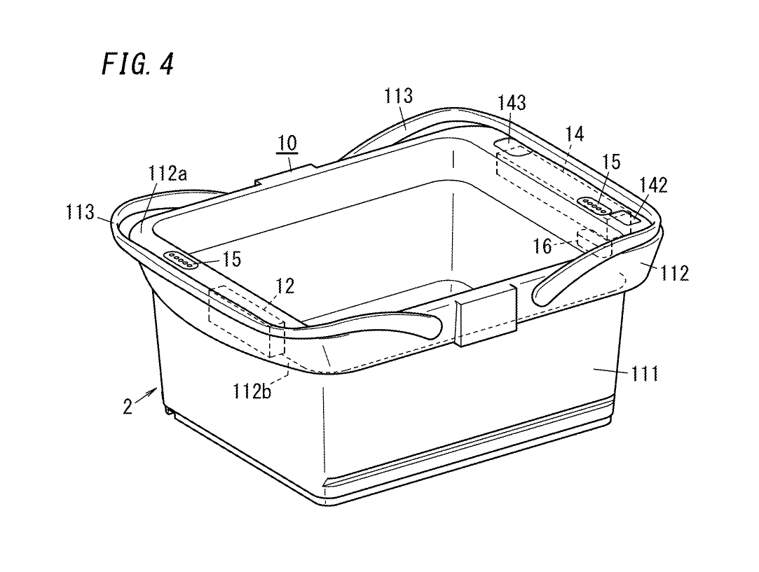

The information acquisition system 100 assumed here constitute, along with a selling system 3, a shopping assistance system 200 configured to be installed in the store 4 and support customers' (5) shopping (see FIG. 8). The selling system 3 is configured to perform a selling process of one or more articles as one or more goods. In the embodiment, the selling system 3 includes a store device 31. For example, a register counter of the store 4 is provided with the store device 31 equipped with functions of a checkout process and the like. The shopping basket 1 includes a body 10 (see FIG. 4) that allows at least, one or more goods to be put in, a reader 141 configured to read respective one or more pieces of goods information on the one or more goods, a storage 144 configured to store the read one or more pieces of goods information, and a wireless unit 147. When being put on the register counter, the shopping basket 1 causes the wireless unit 147 to transmit the one or more pieces of goods information to the store device 31. This configuration enables the store device 31 to perform a checkout process of the one or more goods based on the one or more pieces of goods information received from the shopping basket 1.

Introducing the shopping baskets 1 into the store enables customers (users) 5 to finish purchasing goods by a process of, in the store, picking up goods to put them in the shopping basket 1 and then proceeding to checkout by the store device 31. That is, the shopping basket 1 is able to read goods information, and therefore an item of goods is put in the body 10 of the shopping basket 1, thereby enabling the shopping basket 1 to acquire goods information on the item of goods. Respective pieces of goods information on goods put in the shopping basket 1 are transmitted from the shopping basket 1 to the store device 31 to be utilized for a checkout process and the like. Thus, the shopping baskets 1 are introduced into the store 4, thereby saving store employees (clerks) and customers 5 some trouble to enable reduction in time taken, for example, from start of the checkout process to customers 5 getting the goods and therefore time taken for customers' (5) shopping.

Here, the information acquisition system 100 according to the embodiment possesses a configuration below, thereby acquiring state information from the shopping basket (transport device) 1. That is, the information acquisition system 100 includes the shopping basket(s) 1, a communication unit 21 and a controller (receiver) 22.

The shopping basket 1 allows one or more goods (articles) to be put on or in and is used for transportation of the one or more goods in the store (facility) 4. The communication unit 21 is configured to communicate with the shopping basket 1. The controller 22 is configured to acquire state information on the shopping basket 1 through the communication between the communication unit 21 and the shopping basket 1.

As stated above, the present embodiment is able to acquire information on a state of the shopping basket (transport device) 1, thereby enabling an administrator (e.g., a store manager of the store 4 or the like) to grasp the information on the shopping basket 1.

The information acquisition system 100 according to the embodiment possesses a configuration below, thereby acquiring state information from the shopping basket (transport device) 1 to provide the state information to a main management system (management system) 61. That is, the information acquisition system 100 further includes an output unit 25. The “main management system 61” stated in the disclosure is configured to manage two or more stores (facilities) 4 into which their respective information acquisition systems 100 are introduced. Examples of the “facilities” stated in the disclosure include: facilities 4 under the management of one company, such as chain stores; facilities 4 whose executives are different from each other, such as family type operations; and combinations of the facilities 4 of the former and the facilities 4 of the latter. That is, the “facilities” need to be a group of facilities 4 into which their respective information acquisition systems 100 are introduced.

Each of the stores 4 is provided with the shopping basket(s) 1 that allows one or more goods (articles) to be put on or in and is used for transportation of the one or more goods. The output unit 25 is configured to provide the main management system 61 with the one or more pieces of state information acquired through the controller 22. In short, each of the stores 4 is provided with the information acquisition system 100 that is configured to acquire state information on the shopping baskets 1 in a corresponding store 4 to provide the acquired state information to an outside of the store 4 (main management system 61).

As stated above, in the present embodiment, the information on a state of the shopping basket (transport device) 1 acquired in the store (facility) 4 is provided to the main management system 61. This configuration enables the main management system 61 to collect information on a state of each shopping basket 1 from the stores 4 into which their respective information acquisition systems 100 are introduced. It is therefore possible for an administrator of the main management system 61 (e.g., a service provider of the information acquisition systems 100) to grasp information on each shopping basket 1 in the stores 4.

### (2) Details

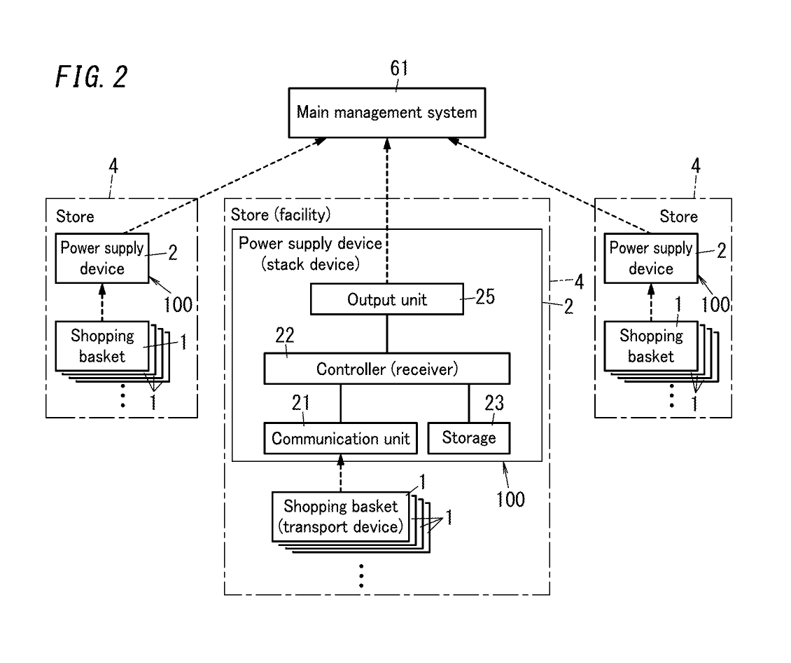

A configuration of the information acquisition system 100 according to the present embodiment will hereinafter be explained in detail. Hereinafter, unless otherwise noted, one store 4 is described as representative of stores 4 into which their respective information acquisition systems 100 are introduced. The explanation below applies not only to the one store 4 but also to the others. This also applies to “(3) Operation” to be described later. As shown in FIGS. 1 and 2, the information acquisition system 100 according to the embodiment includes one or more (here, two or more) shopping baskets 1, the communication unit 21, the controller 22, the output unit 25 and a subsidiary management system 62. In an example be explained in the embodiment, each shopping basket 1 used at convenience stores exemplifies the transport device 1, and goods in convenience stores exemplify articles. Note that the communication unit 21, the controller 22, the output unit 25 and the subsidiary management system 62 will be described later in “(2.3) Power supply device and information acquisition system”.

### (2.1) Shopping Assistance System

Overall structure of the shopping assistance system 200 with the shopping baskets 1 according to the present embodiment will first be explained with reference to FIGS. 1 to 3. The shopping assistance system 200 includes the information acquisition system 100 and the selling system 3 including the store device 31. The selling system 3 also includes a bagging device (machine) 32.

In the embodiment, a register counter 45 of the store (convenience store) 4 is provided with the store device 31 (see FIG. 8). The store device 31 possesses a function of communication with shopping baskets 1, and is configured to, when a shopping basket 1 is put in a checkout space in the register counter 45, communicate with the shopping basket 1 to acquire one or more pieces of goods information therefrom.

Here, when picking up an item of goods in the store to put it in the shopping basket 1, customers 5 cause the reader 141 of the shopping basket 1 to read goods information on the item of goods. The shopping basket 1 stores the goods information read from the item of goods through the reader 141 in the storage 144. Therefore, when one item of goods is put in the shopping basket 1, the goods information on the item of goods is stored in the storage 144 of the shopping basket 1. Similarly, when two or more items of goods are put in the shopping basket 1, respective two or more pieces of goods information on the two or more items of goods are stored in the storage 144 of the shopping basket 1. When being put in the checkout space in the register counter 45, the shopping basket 1 causes the wireless unit 147 to transmit one or more pieces of goods information stored in the storage 144 to the store device 31.

The store device 31 then acquires the one or more pieces of goods information transmitted from the shopping basket 1 in this way, thereby acquiring one or more pieces of goods information on one or more goods put in the shopping basket 1. Therefore, work of reading one or more pieces of goods information on one or more goods put in the shopping basket 1 is not required at the register counter 45. The store device 31 performs a checkout process of the one or more goods based on the one or more pieces of goods information acquired from the shopping basket 1. Thus, the shopping baskets 1 are introduced into the store 4, thereby saving store (4) employees (clerks) and customers 5 some trouble to enable reduction in time taken, for example, from start of the checkout process to customers 5 getting the goods and therefore time taken for customers' (5) shopping.

The bagging device 32 is configured to perform “bagging” for transferring one or more goods from the shopping basket 1 into a container for carrying home. Examples of the container for carrying home include sacks, baskets, boxes, carts, bags and the like. In an example assumed in the present embodiment, the container for carrying home may be a shopping bag made from polyethylene or polypropylene (what is called a plastic shopping bag). That is, after the checkout process is completed, customers 5 are to carry home one or more goods that have been transferred from the shopping basket 1 into the container for carrying home (in the embodiment, shopping bag). Although in general it is necessary to perform work of “bagging” for transferring one or more goods from the shopping basket 1 into the shopping bag, in the embodiment, such work of “bagging” is automatically performed by the bagging device 32, and therefore unnecessary for store clerks or customers 5 to perform.

As an example, the bagging device 32 may be built in the register counter 45. For example, the bagging device 32 may possess a mechanism configured to open and close a bottom (bottom panel(s)) of the body 10 of each shopping basket 1. When a shopping basket 1 is put in the checkout space in the register counter 45, the bagging device 32 opens the bottom of the body 10 of the shopping basket 1 to eject one or more goods from the opened bottom of the body 10 of the shopping basket 1. When the one or more goods are ejected from the bottom of the shopping basket 1, the bagging device 32 puts the one or more goods into a shopping bag in the register counter 45. Thus, the bagging of the one or more goods is completed in the register counter 45 in a state where the shopping basket 1 is put in the checkout space in the register counter 45. The shopping basket 1 is then removed from the checkout space. In this state, the bagging device 32 ejects, on the checkout space in the register counter 45, the one or more goods that are in a bagged state—namely bagged into the shopping bag. It is accordingly possible for customers 5 to carry home the bagged one or more goods put on the register counter 45.

The bagging device 32 is configured to communicate with the store device 31 so as to work in tandem with the store device 31. That is, the bagging device 32 possesses a function of communication with the store device 31. In the embodiment, when a shopping basket 1 is put in the checkout space, the shopping assistance system 200 is configured to first cause the store device 31 to communicate with the shopping basket 1 to acquire one or more pieces of good information from the shopping basket 1. The store device 31 finishes acquiring the one or more pieces of goods information and then transmits a bagging start signal to the bagging device 32. When receiving the bagging start signal from the store device 31, the bagging device 32 starts “bagging” one or more goods. When the store device 31 finishes the checkout process and the shopping basket 1 is removed from the checkout space, the store device 31 transmits an ejection start signal to the bagging device 32. When receiving the ejection start signal from the store device 31, the bagging device 32 ejects the bagged one or more goods on the checkout space.

With the shopping assistance system 200, when a shopping basket 1 is put in the checkout space in the register counter 45, bagging of one or more goods is started. While the checkout process is performed according to customers' (5) operation, the bagging of the one or more goods is completed. After the checkout process is completed, the one or more goods are handed over to customers 5. Therefore, except the customers' (5) operation, it is possible to release customers 5 and store clerks from some trouble till the bagged one or more goods are handed over after customers 5 put the shopping basket 1 in the checkout space in the register counter 45. It is consequently possible to save customers 5 and store clerks some trouble during customers' shopping in comparison with conventional shopping in which customers 5 or store clerks perform work of reading goods information and bagging the goods.

In the shopping assistance system 200 according to the embodiment, the customers 5 basically take out (remove) the shopping basket 1 from the checkout space. Specifically, when ejection of goods from the shopping basket 1 is completed, the bagging device 32 closes the bottom of the shopping basket 1. For example, the store device 31 subsequently causes a display or voice output device to issue notification so as to encourage customers 5 to return the shopping baskets 1 to a basket storage area 46. According to the notification, the customers 5 return the empty shopping basket 1 put on the checkout space to the basket storage area 46 (see FIG. 8). A power supply device 2 is installed at the basket storage area 46. The shopping basket 1 is stacked against the power supply device 2, thereby returning to the basket storage area 46.

Herein, each shopping basket 1 includes a secondary battery 12 as a power supply for operation of an electric circuit 14 including the reader 141 and the like. That is, the secondary battery 12 supplies electric power for operation of the shopping basket 1 (electric circuit 14) in use. The shopping baskets 1 (secondary batteries 12) therefore require charging after use thereof. Therefore, in the embodiment, the power supply device 2 is configured to charge one or more shopping baskets 1 put at the basket storage area 46. In other words, each shopping basket (transport device) 1 possesses its own secondary battery 12 to be charged by the charging power supplied from the power supply device 2.

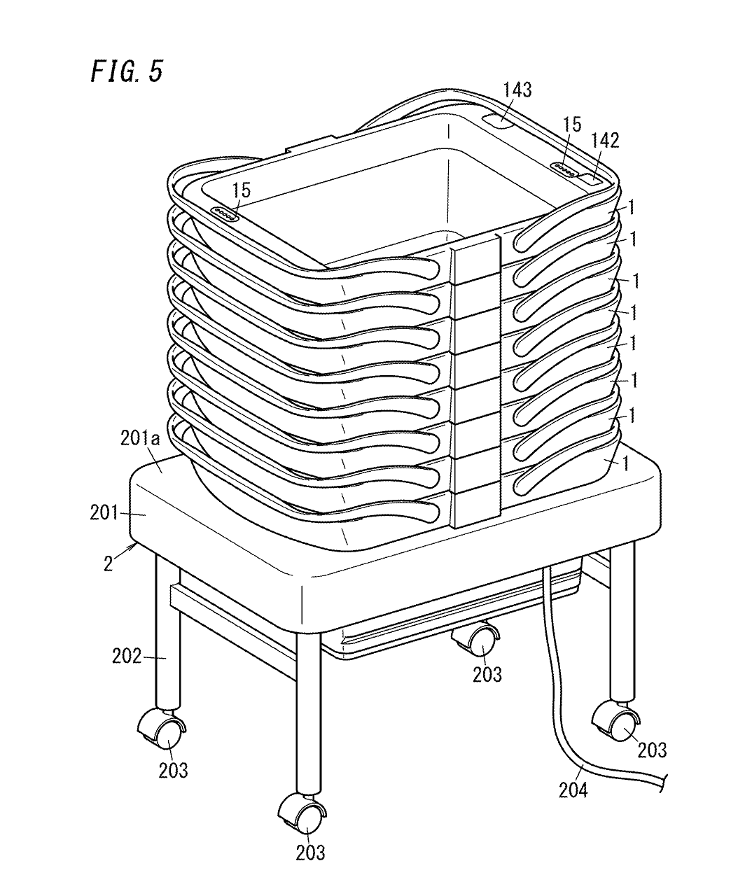

As shown in FIG. 5, the embodiment is configured to charge shopping baskets 1 stacked in a row (in a stacked state). That is, in the embodiment, one power supply device 2 put at the basket storage area 46 charges the shopping baskets 1 stacked in a longitudinal direction (vertical direction).

Thus, the power supply device 2 in the embodiment doubles as a stack device 2 that allows unused shopping baskets (transport devices) 1 to be stacked on. Unless otherwise noted, the stack device is also referred to as the “power supply device”.

Here, the power supply device 2 and shopping baskets 1 stacked thereon (i.e., connected thereto) are daisy chain connected to at least a power supply line for charging power with the power supply device 2 being as a top node. In other words, the shopping baskets 1 are connected together in sequence to the power supply device 2 on the power supply line for charging power. Here, a side of the power supply device 2 as seen from the shopping baskets 1 is an “upper” side, while an opposite side of the shopping baskets 1 from the power supply device 2 is a “lower” side. In the present disclosure, an upper node (power supply device 2 or shopping basket 1) directly connected to any one of shopping baskets 1 stacked on the power supply device 2 is referred to as an “adjoining upper node” thereof. Similarly, a lower node (shopping basket 1) directly connected to any one of the power supply device 2 and the shopping baskets 1 stacked thereon is referred to as an “adjoining lower node” thereof.

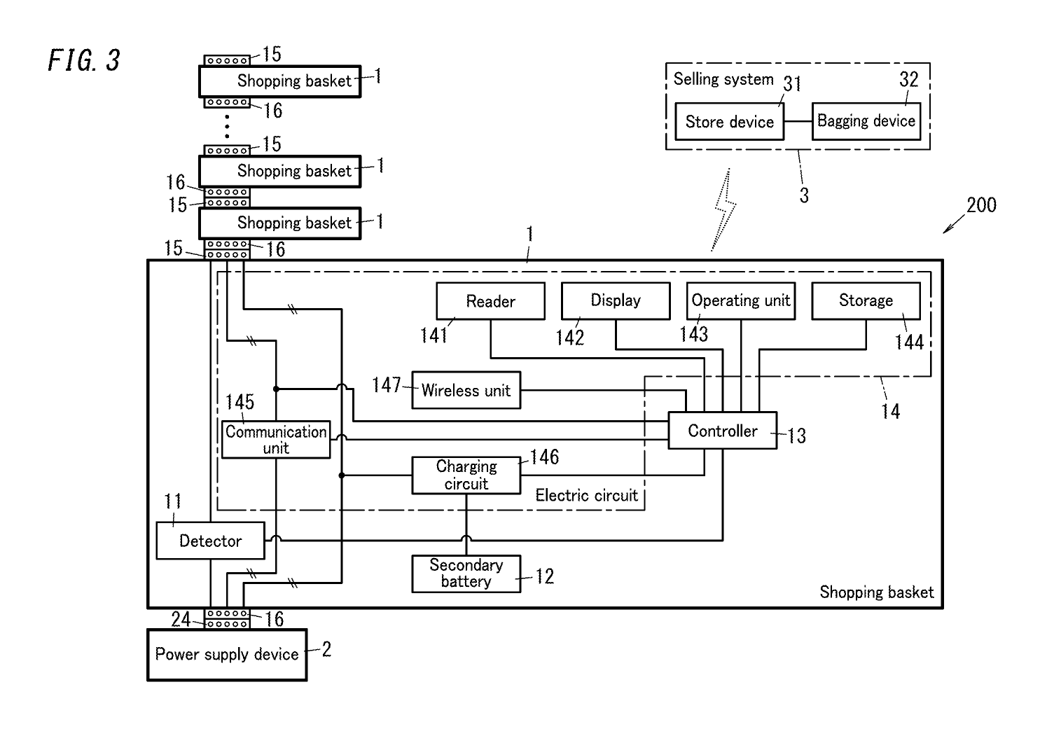

In the embodiment, the power supply device 2 and each shopping basket 1 possess an output terminal 24 and an output terminal 15, to be connected with an adjoining lower node, respectively (see FIG. 3). The power supply device 2 and each shopping basket 1 are configured to switch between an energized state and a de-energized state. Here, the energized state is a state allowing charging power to be output, while the de-energized state is a state prohibiting the charging power from being output. In the embodiment, each of the power supply device 2 and the shopping baskets 1 is configured to, when the authentication of the adjoining lower node succeeds, switch from the de-energized state to the energized state. Therefore, the power supply device 2 and each shopping basket 1 output charging power from the output terminal 24 and the output terminal 15 when the shopping basket 1 as the adjoining lower node is correctly connected to the output terminal 24 and the output terminal 15, respectively.

In the embodiment, the power supply device 2 and shopping baskets 1 stacked thereon are daisy chain connected not only to the power supply line for charging power but also to a communication line with the power supply device 2 being as the top node. Specifically, in addition to the output terminal 15, each of the shopping baskets 1 further includes an input terminal 16 that allows an output terminal 24 or 15 of its own adjoining upper node to be connected to.

Thus, each of shopping baskets 1 stacked on the power supply device 2 is connected to the power supply device 2 directly or indirectly through one or more other shopping baskets 1. This configuration enables the power supply device 2 to supply electric power to the shopping baskets 1 stacked on the power supply device 2. Each of the shopping baskets 1 receives the electric power from the power supply device 2 to cause a charging circuit 146 thereof to charge a corresponding secondary battery 12.

### (2.2) Shopping Basket

A configuration of each shopping basket 1 will next be explained with reference to FIGS. 3 to 5. Each shopping basket 1 includes the body 10, a detector 11, the secondary battery (battery) 12, a controller 13, the electric circuit 14, the output terminal 15 and the input terminal 16. Although FIG. 3 shows a circuit configuration of each shopping basket 1, the body 10 is not shown therein.

As shown in FIG. 4, the body 10 possesses a storage 111 shaped like a box with at least an opening in an upper face thereof, a flange 112 provided around a periphery of the opening, and a pair of handles 113. The body 10 allows goods to be put in the storage 111. The flange 112 is continuous around an upper end part of the storage 111 to form a frame surrounding the opening of the storage 111. Therefore, when the body 10 of a shopping basket 1 is stacked on the power supply device 2 or a different (or another) shopping basket 1, as the adjoining upper node, the storage 111 thereof is inserted into a space surrounded by a frame body 201 of the power supply device 2 (see FIG. 5) or a space surrounded by the flange 112 of the different shopping basket 1. In this state, a lower face 112b of the flange 112 of the shopping basket 1 is in contact with an upper face 201a of the frame body 201 of the power supply device 2 or an upper face 112a of the flange 112 of the different shopping basket 1, as the adjoining upper node. The pair of handles 113 is tiltable, and both base ends of each handle 113 are supported by the flange 112.

The electric circuit 14 includes various circuit modules configured to be activated by receiving electric power supplied from the secondary battery 12. In the embodiment, the electric circuit 14 includes the reader 141, a display 142, an operating unit 143, the storage 144, a communication unit 145, the charging circuit 146, and the wireless (communication) unit 147.

The reader 141 is configured to read one or more pieces of goods information (or product information) on one or more goods from the one or more goods. The “goods information” stated in the disclosure is information for identification of each item of goods (goods (or product) identification code), and examples thereof include Japanese article number (JAN) codes used in Japan, and the like. The goods information is not limited to information for identification of goods (or product) type (kind), but may contain information such as serial information for individually identifying the same type of goods. This configuration makes it possible to, even in the case of presence of the same type of goods, individually identify the same type of goods based on their respective pieces of goods information. Examples of the reader 141 include bar code readers, readers configured to read a two-dimensional code, tag readers, image sensors (detectors) and the like. The tag reader stated herein possesses a function configured to read goods information from a radio frequency (RF) tag attached to an item of goods in a contactless manner, and forms a radio frequency identification (RFID) system. The lower face 112b of the flange 112 is provided with the reader 141.

Examples of the display 142 include seven-segment LEDs, liquid crystal displays, and the like. The display 142 is configured to perform display based on, for example, one or more pieces of goods information read through the reader 141, and the like. Specifically, the display 142 may display the number of goods corresponding to the number of one or more pieces of goods information stored in the storage 144. The upper face 112a of the flange 112 is provided with the display 142.

The operating unit 143 includes, for example a push switch(es), and is configured to allow customers 5 to enter their operation through the push switch. Specifically, the operating unit 143 may receive an operation for switching from an operation mode of the reader 141 to a return mode for allowing return of an item of goods whose goods information has been read by the reader 141 (purchase cancellation). This configuration enables customers 5 to, when cancelling purchase of an item of goods whose goods information has been read once in order to purchase it, perform operation through the operating unit 143, thereby returning the item of goods. The upper face 112a of the flange 112 is provided with the operating unit 143.

Examples of the storage 144 include rewritable nonvolatile memories such as electrically erasable programmable read-only memories (EEPROMs), volatile memories such as random access memories (RAMs), combinations of the rewritable nonvolatile memories and the volatile memories, and the like. The storage 144 is configured to store at least, state information on the shopping basket 1, and one or more pieces of goods information read through the reader 141. The storage 144 is able to store two or more pieces of goods information. Therefore, when the reader 141 reads two or more pieces of goods information from two or more goods, the two or more pieces of goods information are stored in the storage 144.

Examples of the state information include battery information, identification information, version information representing a version of software installed in the shopping basket 1 and/or a version of hardware. The “battery information” stated in the disclosure may be information representing a state of the battery (secondary battery 12) for supply of operating power of the shopping basket 1, specifically such as charging voltage and the number of charge cycles of the secondary battery 12. The “identification information” stated in the disclosure may be unique information assigned to the shopping basket 1 in order to individually distinguish the shopping baskets 1, specifically such as individual communication addresses assigned to the shopping baskets 1. Note that the identification information may be, for example the manufacturing number of each shopping basket 1.

The examples of the state information may further include usage information representing whether or not the shopping basket (transport device) 1 is in use. In the embodiment, the usage information is represented by presence (occurrence) or absence of stack detected by the detector 11 to be described later. That is, when a result of detection by the detector 11 represents “presence of stack”, the shopping basket 1 is stacked on the power supply device 2 or a different shopping basket 1—namely the shopping basket 1 is put at the basket storage area 46, and therefore the shopping basket 1 is out-of-use—not used by any customer 5. On the other hand, when the result of detection by the detector 11 represents “absence of stack”, the shopping basket 1 is not stacked on any of the power supply device 2 and a different shopping basket 1—namely the shopping basket 1 leaves the basket storage area 46, and therefore the shopping basket 1 is in use—used by a customer 5. Thus, according to whether or not the shopping basket (transport device) 1 is stacked on the power supply device (stack device) 2, the state information may represent whether or not the shopping basket 1 is out-of-use.

The examples of the state information may further include position information of the store 4 (e.g., latitude and longitude), and area information on a region where the store 4 is located (e.g., prefectures of Japan or the like).

The communication unit 145 is configured to communicate with the power supply device 2. In the embodiment, examples of a communication method of the communication unit 145 include serial communication with a universal asynchronous receiver transmitter (UART). In this case, the communication unit 145 may communicate with the power supply device 2 in a two-way manner through two wires for transmission (TxD) and reception (RxD). When shopping baskets 1 are daisy chain connected to the power supply device 2, the power supply device 2 communicates individually with the shopping baskets 1 based on respective addresses assigned to the shopping baskets 1.

The charging circuit 146 is configured to receive electric power supplied from the power supply device 2 to charge the secondary battery 12. Herein, the charging circuit 146 includes a DC/DC converter configured to step down DC voltage applied from the power supply device 2.

The wireless unit 147 is configured to communicate with the store device 31 by optical wireless communication whose medium is light such as, for example, infrared radiation or visible radiation, or wireless communication whose medium is radio waves. The wireless unit 147 possesses a function configured to transmit at least one or more pieces of goods information stored in the storage 144 to the store device 31.

The secondary battery 12 is, for example a lithium-ion battery. The secondary battery 12 is configured to supply electric power to the electric circuit 14, thereby activating the electric circuit 14. In the embodiment, the secondary battery 12 may supply operating power to electric devices (or circuit modules) other than the electric circuit 14, such as the detector 11 and the controller 13.

The output terminal 15 is, for example a connector with five contacts that include two contacts for output of charging power (Vcc and GND), two contacts for communication (T×D and R×D), and an output contact for detection. The output terminal 15 of the shopping basket 1 allows a different shopping basket 1 to be electrically connected to, and possesses at least a function configured to output charging power. The output contact for detection functions as an output contact of a signal (IRQ signal) for detecting connection between a corresponding shopping basket 1 and the adjoining lower node thereof. The upper face 112a of the flange 112 is provided with the output terminal 15. Here, the output terminal 15 is, for example a pad connector configured so that respective faces of the contacts fixed to the body 10 are exposed from the upper face 112a of the flange 112. In the embodiment, one body 10 is provided with two or more (here, two) output terminals 15. This configuration enables any one of the output terminals 15 to be connected to the input terminal 16 of a different shopping basket 1 not only when the different shopping basket 1 is put on the body 10 of the shopping basket 1 in an orientation shown in FIG. 5, but also when the different shopping basket 1 is put on the body 10 of the shopping basket 1 in an orientation opposite thereto.

The input terminal 16 is a connector with five contacts, corresponding to those of the output terminal 15. That is, the input terminal 16 possesses the five contacts that include two contacts for input of charging power (Vcc and GND), two contacts for communication (TxD and ReD), and one input contact for detection. The input terminal 16 of the shopping basket 1 allows the power supply device 2 or a different shopping basket 1 to be electrically connected to, and is configured to receive at least charging power. The input contact for detection functions as an input contact of a signal (IRQ signal) for detecting connection between a corresponding shopping basket 1 and the adjoining upper node thereof. The lower face 112b of the flange 112 is provided with the input terminal 16. Specifically, the input terminal 16 is disposed at a location that allows an output terminal 15 or 24 of the adjoining upper node to face the input terminal 16 when the body 10 of the shopping basket 1 is stacked on the power supply device 2 or the different shopping basket 1, as the adjoining upper node.

The detector 11 is configured to detect presence (occurrence) of the “stack state” in which the body 10 of the shopping basket 1 is stacked relative to a detection target (the power supply device 2 or a different shopping basket 1). That is, when the body 10 of the shopping basket 1 is stacked relative to the power supply device 2 or a different shopping basket 1 as the detection target, the detector 11 detects the occurrence of the stack state, and thereby a result of detection by the detector 11 changes from “absence of stack” to “presence of stack”. For example, when the shopping basket 1 is stacked on the power supply device 2 disposed at the basket storage area 46, the detector 11 of the shopping basket 1 detects the occurrence of the stack state in which it is stacked on the power supply device 2 as the detection target. When the shopping basket 1 is stacked on the different shopping basket 1 located on the first row from the bottom to be located on the second row from the bottom, the detector 11 of the shopping basket 1 located on the second row detects the occurrence of stack state in which it is stacked on the different shopping basket 1 as the detection target.

In the embodiment, the detector 11 is configured to, when the shopping basket 1 thereof is electrically connected to the detection target, detect the occurrence of stack state. Specifically, the detector 11 of the shopping basket 1 may detect whether or not the input contact for detection in the input terminal 16 of the shopping basket 1 is connected to an output terminal 24 or 15 of the adjoining upper node (the power supply device 2 or a different shopping basket 1). As one example, the detector 11 may detect, according to a signal level of an interrupt request (IRG) signal supplied to the input contact for detection in the input terminal 16 of the shopping basket 1, whether or not the input terminal 16 is connected to the power supply device 2 or a different shopping basket 1. In this case, when a value of electric potential on the input contact for detection in the input terminal 16 reaches a predetermined value, the detector 11 may detect occurrence of stack state with the adjoining upper node.

The controller 13 is configured to control the detector 11, the electric circuit 14 and the like. For example, the controller 13 is mainly composed of a computer (including a microcomputer) including a processor and a memory. That is, the computer causes the processor to execute an appropriate program stored in the memory, thereby functioning as the controller 13.

### (2.3) Power Supply Device and Information Acquisition System

Respective configurations of the power supply device 2 and the information acquisition system 100 will next be explained with reference to FIGS. 2 and 5. As one example, the power supply device 2 is located at the basket storage area 46 near an entrance 41 of the store 4 or near the register counter 45 (see FIG. 8). The power supply device 2 illustrated in the embodiment possesses casters 203 and is movable on the floor in particular. This configuration therefore renders change of installation location easy.

As shown in FIG. 5, the power supply device 2 possesses the frame body 201, a support 202, the casters 203, a power cable 204 and the output terminals 24 (see FIG. 3).

The frame body 201 is in the shape of a frame with an opening pierced in a longitudinal direction (vertical direction). In the embodiment, the frame body 201 is in the shape of a rectangular frame. The support 202 supports the frame body 201 at a position separated from the floor surface by a predetermined distance. The casters 203 are fixed to a bottom of the support 202. The power cable 204 is drawn out from the frame body 201. The power cable 204 is a cable for supply of electric power to an internal circuit of the power supply device 2, and configured to be connected to, for example an outlet.

The internal circuit is built in the frame body 201. The internal circuit is configured to supply shopping baskets 1 with electric power (charging power) for charging their respective secondary batteries 12. In the embodiment, the internal circuit of the power supply device 2 includes an AC/DC converter configured to convert AC voltage into DC voltage to supply the DC voltage to the shopping baskets 1. However, the disclosure is not limited to this example. The internal circuit of the power supply device 2 may be configured to directly supply the shopping baskets 1 with AC voltage or DC voltage from an outside, and provided with no AC/DC converter.

The communication unit 21, the controller 22, a storage 23 and the output unit 25 are also built in the frame body 201. The communication unit 21 functions as a communication unit in the information acquisition system 100. That is, the communication unit 21 possesses a function configured to communicate with one or more shopping baskets (transport devices) 1 stacked on the power supply device 2. The communication unit 21 includes the output terminals 24 for serial communication, and a wireless communication module. The communication unit 21 may individually communicate with one or more shopping baskets 1 stacked on the power supply device 2 through the output terminals 24 based on one or more addresses assigned to the one or more shopping baskets 1. Thus, the communication unit 21 is able to communicate with one or more shopping baskets 1 stacked on the power supply device 2.

As one example of the embodiment, each of the output terminals 24 is a connector with five contacts that include two contacts for output of charging power (Vcc and GND), two contacts for communication (T×D and R×D), and an output contact for detection. The upper face 201a of the frame body 201 is provided with the output terminals 24. Here, each of the output terminals 24 is, for example a pad connector, and configured so that respective faces of the contacts fixed to the frame body 201 are exposed from the upper face 201a of the frame body 201. In the embodiment, one frame body 201 is provided with two or more (here, two) output terminals 24 in the same way as the output terminals 15 of each shopping basket 1. This enables any one of the output terminals 24 to be connected to the input terminal 16 of a shopping basket 1 not only when the shopping basket 1 is put on the power supply device 2 in an orientation shown in FIG. 5, but also when the shopping basket 1 is put thereon in an orientation opposite thereto.

The communication unit 21 is configured to cause the wireless communication module to communicate with the subsidiary management system 62 by optical wireless communication whose medium is light such as, for example, infrared radiation or visible radiation, or wireless communication whose medium is radio waves.

The subsidiary management system 62 is, for example, a server and mainly composed of a computer including a processor and a memory. That is, the computer causes the processor to execute an appropriate program stored in the memory, thereby functioning as the subsidiary management system 62. In the embodiment, the subsidiary management system 62 is configured to communicate with the communication unit 21 of the power supply device 2 through the store device 31, thereby collecting respective pieces of state information of shopping baskets 1 stored in the storage 23 of the power supply device 2. Alternatively, the subsidiary management system 62 may directly communicate with the communication unit 21 of the power supply device 2, thereby collecting the respective pieces of state information. The subsidiary management system 62 may also manage information based on the respective pieces of state information collected from the shopping baskets 1. That is, the subsidiary management system 62 may manage information based on the respective pieces of state information acquired through the controller (receiver) 22.

For example, based on the respective pieces of state information of the shopping baskets 1, the subsidiary management system 62 may produce and manage information on usage of each of the shopping baskets 1 in the store 4. For example, the subsidiary management system 62 may also produce and manage information on respective deterioration conditions of the secondary batteries 12 of the shopping baskets 1 based on respective pieces of battery information of the shopping baskets 1. Thus, the subsidiary management system 62 may apply appropriate processing to the respective pieces of state information, thereby managing information based on respective pieces of state information acquired through the processing, and not manage information itself based on respective pieces of state information of the shopping baskets 1 acquired through the controller 22. It is possible for the administrator (here, the store manager of the store 4) to access the subsidiary management system 62 by using, for example an information terminal such as a personal computer, thereby browsing the information managed by the subsidiary management system 62.

The output unit 25 includes, for example a wireless communication module. The output unit 25 is configured to communicate with the main management system 61 through a network such as the Internet by optical wireless communication whose medium is light such as, for example, infrared radiation or visible radiation, or wireless communication whose medium is radio waves. The output unit 25 may be connected to the network through a communication device such as, for example a router.

The main management system 61 is, for example a server and mainly composed of a computer including a processor and a memory. That is, the computer causes the processor to execute an appropriate program stored in the memory, thereby functioning as the main management system 61. In the embodiment, the main management system 61 is configured to communicate with the output unit 25 of each power supply device 2 in the stores 4, thereby collecting and managing respective pieces of state information of shopping baskets 1 stored in the storage 23 of each power supply device 2. In other words, each output unit 25 provides the main management system 61 with respective pieces of state information of shopping baskets 1 acquired through a corresponding controller (receiver) 22. For example, in order to collect respective pieces of state information of shopping baskets 1 at regular intervals, the main management system 61 may request the stores 4 to transmit the respective pieces of state information. Alternatively, when part or all of respective state information of the shopping baskets 1 are renewed, a corresponding output unit 25 may for example voluntarily provide the main management system 61 with at least one or more pieces of state information renewed.

The main management system 61 may manage information based on respective pieces of state information of shopping baskets 1 collected from each of the stores 4. For example, the main management system 61 may produce and manage information on usage of each of shopping baskets 1 in each of the stores 4 based on respective pieces of usage information of the shopping baskets 1. In addition, for example, the main management system 61 may produce and manage information on respective deterioration conditions of the secondary batteries 12 of shopping baskets 1 in each of the stores 4 based on respective pieces of battery information of the shopping baskets 1. Thus, the main management system 61 may not only manage information based on respective pieces of state information of shopping baskets 1 acquired through the controller 22 in each store 4, but also apply appropriate processing to the respective pieces of state information to manage information based on respective pieces of state information acquired through the processing. It is possible for the administrator (here, the service provider of the information acquisition system) to access the main management system 61 by using an information terminal such as, for example a personal computer, thereby browsing the information managed by the main management system 61.

Thus, in the embodiment, the main management system 61 is configured to collect plural pieces of state information from the information acquisition system 100 in each of the stores (facilities) 4, thereby managing the stores 4. Each of the stores 4 is provided with the information acquisition system 100. Note that in the embodiment the main management system 61 is a system different from the information acquisition system 100 and different from components of the information acquisition system 100, but may be included in any of the information acquisition systems 100.

The controller 22 is configured to control the communication unit 21 and the like. The controller 22 is mainly composed of, for example a computer (including a microcomputer) including a processor and a memory. That is, the computer causes the processor to execute an appropriate program stored in the memory, thereby functioning as the controller 22. In the embodiment, the controller 22 functions as a receiver in the information acquisition system 100. Thus, in the embodiment, each power supply device (stack device) 2 is provided with the communication unit 21, the controller (receiver) 22 and the output unit 25. Unless otherwise noted, the controller 22 is hereinafter referred to as the “receiver 22” when the functions of each information acquisition system 100 are explained. The receiver 22 is configured to when receiving state information stored in the storage 144 of each shopping basket 1 through the communication between the communication unit 21 and the communication unit 145 of a corresponding shopping basket 1, store the received state information by associating it with an identifier (address) of the corresponding shopping basket 1 as the transmission source.

Examples of the storage 23 include rewritable nonvolatile memories such as EEPROMs, volatile memories such as RAMs, combinations of the rewritable nonvolatile memories and the volatile memories, and the like, in the same way as the storage 144 of each shopping basket 1. The storage 23 is configured to store, for each of the identifiers (addresses) associated with shopping baskets 1, state information acquired from a corresponding shopping basket 1. In the embodiment, the storage 23 stores the number of shopping baskets 1 stacked on the power supply device 2 as respective pieces of stack information of the shopping baskets 1. That is, of the shopping baskets 1, the number of shopping baskets 1 whose respective detectors' (11) detection results are “presence of stack” is stored in the storage 23 as the number of the shopping baskets 1 stacked on the power supply device 2.

### (3) Operation

An operation of the information acquisition system 100 according to the embodiment will hereinafter be explained. In the embodiment, an information acquiring operation of the information acquisition system 100 varies according to information content. Therefore, in the explanation of the information acquiring operation of the information acquisition system 100, first and second acquisition examples are exemplified. The information acquisition system 100 may perform the first and second acquisition examples shown below in parallel.

### (3.1) First Acquisition Example

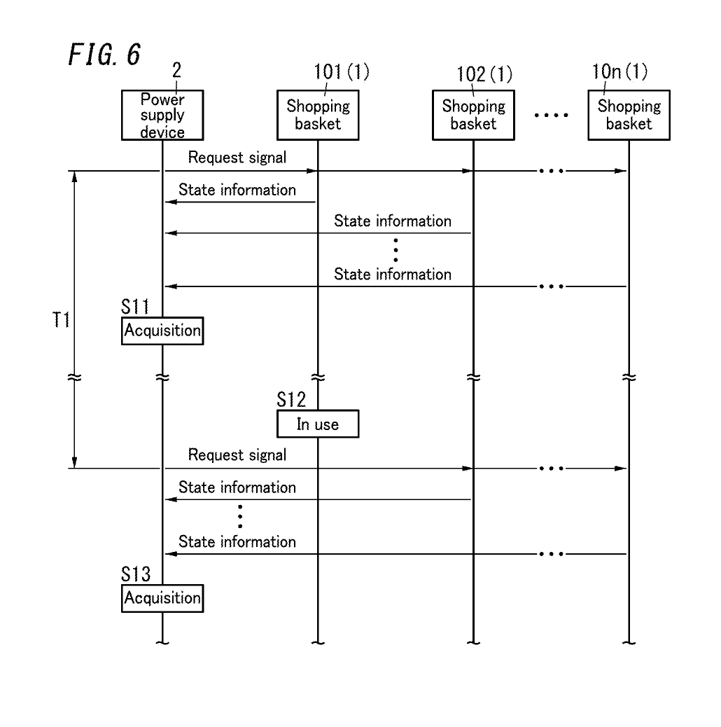

A first acquisition example of the information acquisition system 100 will first be explained with reference to FIG. 6. The first acquisition example is one operational example of the information acquisition system 100 when acquiring, as state information of each shopping basket 1, information that does not require real time, such as for example, battery information, identification information, version information, position information and area information in comparison with usage information. In the example of FIG. 6, it is assumed that up to n (n=natural number) shopping baskets 1 (shopping baskets 101, 102, . . . and 10n) are stacked on one power supply device 2.

In the first acquisition example, the receiver 22 causes the communication unit 21 to transmit a request signal to each of the shopping baskets 101, 102, . . . and 10n at predetermined intervals T1 (e.g., at one-hour intervals). The request signal contains an instruction to return state information stored in the storage 144 of a corresponding shopping basket 1. When each of the shopping baskets 101, 102, . . . and 10n receives the request signal, its own controller 13 reads the state information stored in the storage 144 to cause a corresponding communication unit 145 to transmit the read state information to the communication unit 21 of the power supply device 2. When the receiver 22 of the power supply device 2 receives respective pieces of state information from the shopping baskets 101, 102, . . . and 10n through the communication unit 21, the receiver 22 of the power supply device 2 stores the respective pieces of state information received in the storage 23 by associating them with respective identifiers (addresses) of the shopping baskets 1 as transmission sources. Thus, the receiver 22 of the power supply device 2 acquires the respective pieces of state information from the shopping baskets 101, 102, . . . and 10n at the predetermined intervals T1 (S11).

Here, when of the shopping baskets 101, 102, . . . and 10n, the shopping basket 101 is used by a customer 5 (S12), the communication unit 145 of the shopping basket 101 cannot receive the request signal from the power supply device 2. In this case, the receiver 22 of the power supply device 2 therefore acquires respective pieces of state information of the shopping baskets 102, . . . and 10n other than the shopping basket 101 (S13). When the shopping basket 101 is returned to the stack device 2 after use (i.e., returns to out-of-use), it receives the request signal to transmit the state information of the shopping basket 101, thereby causing the receiver 22 of the power supply device 2 to receive the state information of the shopping basket 101.

### (3.2) Second Acquisition Example

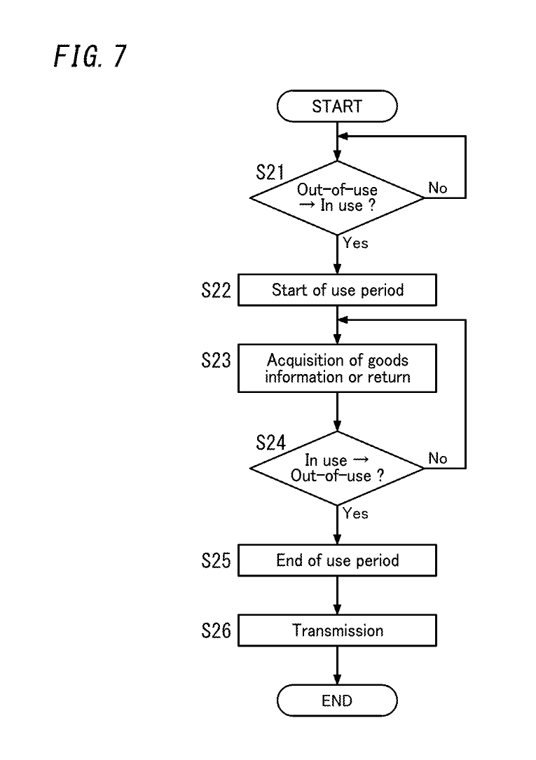

A second acquisition example of the information acquisition system 100 will next be explained with reference to FIG. 7. The second acquisition example is one operational example of the information acquisition system 100 when acquiring, as state information of each shopping basket 1 such as usage information, information that requires real time in comparison with battery information, identification information, version information, position information and area information.

In the second acquisition example, when a shopping basket 1 shifts from “in use” to “out-of-use”, the controller 13 thereof causes the communication unit 145 to transmit the state information stored in the storage 144 to the communication unit 21 of the power supply device 2. At this moment, the controller 13 of the shopping basket 1 causes the communication unit 145 to transmit, to the communication unit 21 of the power supply device 2, not only the state information but also a history of one or more pieces of goods information (article information) acquired in use of the shopping basket 1. That is, in the second acquisition example, the receiver 22 further acquires a history of one or more pieces of goods information (article information) on one or more goods (articles) put on or in the shopping basket 1 during use of the shopping basket 1.

A specific operation of the shopping basket 1 will hereinafter be explained with reference to FIG. 7. The controller 13 of the shopping basket 1 first monitors a result of detection by the detector 11. While the result of detection by the detector 11 is “presence of stack”—namely the shopping basket 1 is stacked on the stack device 2 (i.e., it is out-of-use), the controller 13 performs no operation for acquiring state information in particular (S21: No). On the other hand, when the result of detection by the detector 11 changes from “presence of stack” to “absence of stack”—namely the shopping basket 1 shifts from “out-of-use” to “in use” (S21: Yes), the controller 13 cause, for example a built-in timer to start measuring a period of use for which the shopping basket 1 is used (S22). The controller 13 keeps measuring the period of use till the result of detection by the detector 11 changes from “absence of stack” to “presence of stack”—namely the shopping basket 1 shifts from “in use” to “out-of-use” (S24: No).

While the period of use is measured, if the reader 141 reads goods information, the controller 13 stores the read goods information by associating it with information (time-stamp) on time that the reader 141 reads the goods information. In this case, the controller 13 will acquire one or more pieces of goods information on one or more goods to be purchased by customers 5. The “time” stated in the disclosure may include not only the hours and minutes of the day but also date (day, month and year).

Here, as an example, each shopping basket 1 is provided with a wireless communication function through a network such as the Internet. In this case, a timer of each shopping basket 1 may be synchronized with a time server at regular intervals. Alternatively, as another example, each shopping basket 1 is provided with no wireless communication function. In this case, a timer built in each power supply device 2 may be synchronized with the time server at regular intervals. In addition, the timer may be indirectly synchronized with the time server through the power supply device 2.

In addition, while the period of use is measured, if goods information is read through the reader 141 in operation during the return mode, the controller 13 stores the read goods information in the storage 144 by associating it with information on time that the goods information is read through the reader 141. In this case, the controller 13 acquires goods information on an item of goods to be returned by customers 5. While the period of use is measured, if one or more pieces of goods information on one or more goods to be purchased are read through the reader 141 in this way, the storage 144 stores, as a history of the one or more pieces of goods information, a data set containing the one or more pieces of goods information, and if there is one or more goods returned, one or more pieces of goods information thereon, which are arranged in time series. Note that while the period of use is measured, if there is no goods returned by customers 5, the storage 144 stores, as a history of one or more pieces of goods information on one or more goods to be purchased, a data set containing only the one or more pieces of goods information arranged in time series.

While the period of use is measured, a checkout process for one or more goods to be purchased is formed, the controller 13 stores one or more pieces of goods information, on the one or more goods to be purchased as one or more pieces of goods information on one or more goods purchased, in the storage 144 by associating the one or more pieces of goods information with information on time that the checkout process is performed. In this case, the storage 144 stores, as a history of the one or more pieces of goods information on one or more goods purchased, a goods information set containing not only the one or more pieces of goods information on the one or more goods to be purchased, but also the one or more pieces of goods information on the one or more goods purchased, which are arranged in time series.

Subsequently, when the result of detection by the detector 11 changes from “absence of stack” to “presence of stack”—namely the shopping basket 1 shifts from “in use” to “out-of-use” (S24: Yes), the controller 13 finishes measuring the period of use (S25). Thus, in the second acquisition example, the period of use starts at the time that the shopping basket (transport device) 1 leaves the power supply device (stack device) 2, and ends at the time that the shopping basket 1 is returned to the power supply device 2. Note that the period of use may end when the receiver 22 acquires a history of a goods information (article information) set. Besides, the period of use may end at the time of step S26 to be described later—namely at the time that the shopping basket 1 transmits the goods information set to the selling system 3 at checkout.

At the end of the period of use, the controller 13 then causes the communication unit 145 to transmit the state information and the history of the goods information set stored in the storage 144 to the communication unit 21 of the power supply device 2 (S26). Thus, the receiver 22 of the power supply device 2 acquires the usage information as the state information of the shopping basket 1, and the history of the goods information set during the period of use of the shopping basket 1. The usage information contains at least, information on time that the shopping basket 1 shifts from “out-of-use” to “in use”, and information on time that the shopping basket 1 shifts from “in use” to “out-of-use”.

Here, the history of the goods information set during the period of use corresponds to information on customers' (5) behavior during the period of use in the store 4. It is possible to estimate customer's (5) flow line in the store 4 based on the history of the goods information set by referring to the layout of display shelves and goods in the store 4. For example, when the reader 141 has read respective pieces of goods information on goods “A”, “B” and “C” in this order, it can be estimated that the customer 5 has moved to respective fronts of display shelves of the goods “A”, “B” and “C” in this order.

An example of customer's (5) flow line during the period of use will hereinafter be explained with reference to FIG. 8. In FIG. 8, the customer's (5) flow line is depicted by a dotted line. The customer 5 who enters the store 4 from the entrance 41 first picks up the uppermost shopping basket 1 from shopping baskets 1 stacked on the power supply device 2 at the basket storage area 46 (see “(1)” in FIG. 8). The shopping basket 1 accordingly starts measuring the period of use. The customer 5 then picks up an item of goods, “A” on a display shelf 42, causes the reader 141 to read the goods information, and subsequently puts the item of goods, “A”, in the shopping basket 1 (see “(2)” in FIG. 8). At this moment, the shopping basket 1 stores the goods information on the item of goods, “A”, in the storage 144. The customer 5 then returns to the front of the display shelf 42, causes the reader 141 operating in the return mode to read the goods information, and subsequently returns the item of goods, “A”, on the display shelf 42 (see “(3)” in FIG. 8). At this moment, the shopping basket 1 stores the goods information on the item of goods, “A”, returned in the storage 144.

The customer 5 then moves to the front of a display shelf 43 and the front of a display shelf 44 in this order, causes the reader 141 to read respective pieces of goods information on goods “B” and “C” on the shelves 43 and 44, and subsequently puts them in the shopping basket 1 (see “(4)” and “(5)” in FIG. 8). At this moment, the shopping basket 1 stores the respective pieces of goods information on the goods “B” and “C” in the storage 144.

The customer 5 then moves to the front of the register counter 45 to perform checkout of the goods “B” and “C” put in the shopping basket 1 (see “(6)” in FIG. 8). At this moment, the shopping basket 1 stores the respective pieces of goods information on the goods “B” and “C” purchased. The customer 5 ultimately moves to the front of the basket storage area 46 to return the shopping basket 1 to the power supply device 2 (see “(7)” in FIG. 8), and then leaves the store 4. At this moment, the shopping basket 1 finishes measuring the period of use and stores usage information in the storage 144.

The shopping basket 1 acquires the history of the goods information set in this way. In this case, the history of the goods information set is a data set containing: the goods information on the item of goods, “A”, to be purchased; the goods information on the item of goods, “A”, returned; the respective pieces of goods information on the goods “B” and “C” to be purchased; and the respective pieces of goods information on the goods “B” and “C” purchased, which are arranged in time series. For example, the main management system 61 and/or the subsidiary management system 62 acquiring the history of the goods information set can estimate the customer's (5) flow line based on the history of the goods information set. It is possible for the administrator (e.g., the store manager of the store 4) to browse the customer's (5) flow line estimated by the subsidiary management system 62 to use it for operations of the store 4 in the future, such as changing the layout of display shelves, or changing the layout of goods with good sales. It is also possible for the administrator (e.g., the service provider of the information acquisition system 100) to browse the customer's (5) flow line estimated by the main management system 61 to provide the executive of the store 4 with advice useful for operations of the store 4 in the future, such as changing the layout of display shelves, or changing the layout of goods with good sales.

As stated above, the information acquisition system 100 according to the embodiment is able to acquire state information of each shopping basket (transport device) 1 introduced into the store (facility) 4. The embodiment therefore enable the administrator (e.g., the store manager of the store 4) to grasp respective pieces of information on the shopping baskets 1. That is, the administrator browses information obtained by processing, for example, respective pieces of state information acquired through the information acquisition system 100, or the respective pieces of state information through the subsidiary management system 62, and is thereby able to grasp a situation of the store 4 associated with the respective pieces of state information.

Specifically, the administrator browses battery information as state information of each shopping basket 1, or information obtained by processing the battery information by the subsidiary management system 62, and is thereby able to grasp respective deterioration conditions of the shopping baskets 1. This case enables the administrator to determine whether or not it is necessary to replace any of shopping baskets 1 with new one or ones. The administrator also browses usage information as state information of each shopping basket 1, or information obtained by processing the usage information by the subsidiary management system 62, and is thereby able to grasp usage of each of the shopping baskets 1 in the store 4. This case enables the administrator to, for example when the shopping baskets 1 are insufficient, decide to supplement the shopping baskets 1. Besides, the administrator browses version information as state information of each shopping basket 1, or information obtained by processing the version information by the subsidiary management system 62, and is thereby able to grasp whether or not the version of software and/or hardware is up to date. This case enables the administrator to, for example when the version of the software is not up to date, decide to update the software.

The information acquisition system 100 according to the embodiment also provides the main management system 61 with respective pieces of information on the states of the shopping baskets (transport devices) 1 acquired in the store (facility) 4. This configuration accordingly enables the main management system 61 to collect respective pieces of information on the states of shopping baskets 1 from each of the stores 4 into which the information acquisition system 100 is introduced. It is therefore possible for the administrator (e.g., the service provider of the information acquisition system 100) of the main management system 61 to grasp respective pieces of information on shopping baskets 1 in each of the stores 4. That is, the administrator browses, for example, the pieces of state information acquired through the information acquisition system 100, or information obtained by processing the pieces of state information through the main management system 61, and is thereby able to grasp each situation of the stores 4, associated with corresponding pieces of state information.

Specifically, it is possible for the administrator to grasp respective deterioration conditions of shopping baskets 1 of each of the stores 4 by browsing respective pieces of battery information as respective pieces of state information of the shopping baskets 1, or respective pieces of information obtained by processing the respective pieces of battery information through the main management system 61. This case enables the administrator to determine whether or not it is necessary to replace any of the shopping baskets 1 with new one or ones, and if it is necessary to replace, provide the executive of the store 4 with advice to replace any of the shopping baskets 1.

The administrator also browses respective pieces of usage information as respective pieces of state information of shopping baskets 1 in each of the stores 4, or information obtained by processing the respective pieces of usage information through the main management system 61, and is thereby able to grasp usage of each of the shopping baskets 1 in each store 4. This case enables the administrator to provide the executives of the store 4 with advice to supplement the shopping baskets 1, for example if the shopping baskets 1 are insufficient. The administrator is able to, for example when shopping baskets 1 in any of the stores 4 of the same group are insufficient, provide executives of stores 4 with advice to lend out surplus shopping baskets 1 from other stores 4.

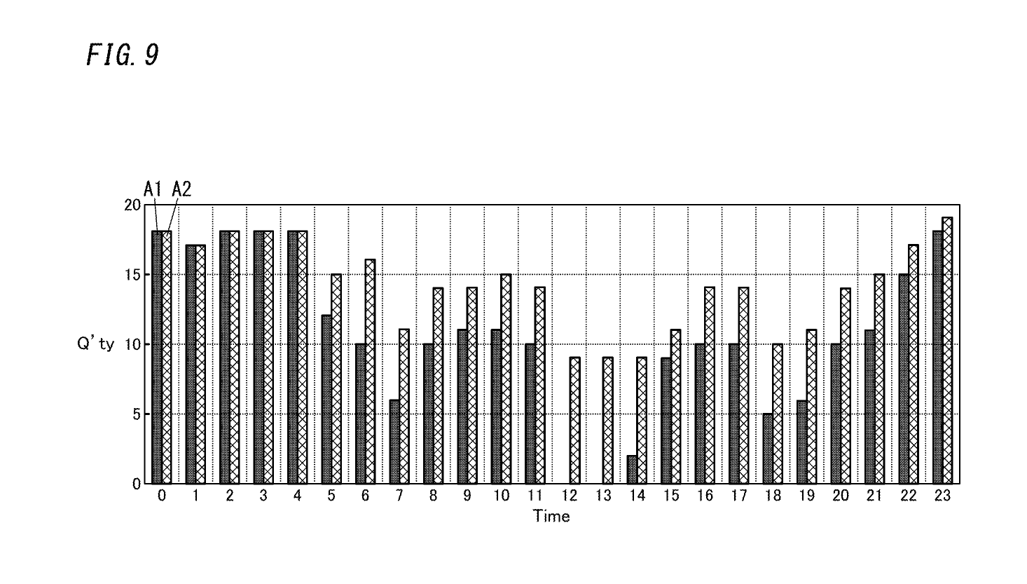

A specific example will hereinafter be explained with reference to FIG. 9. In the explanation below, it is assumed that there are three stores “X”, “Y” and “Z” of the same group, and each of the stores “X”, “Y” and “Z” is provided with 20 shopping baskets 1. In the assumed example below, no excess or deficiency of the shopping baskets 1 has occurred in the store “Y” of the three stores. Therefore, the example of FIG. 9 depicts usage of the shopping baskets 1 in each of the stores “X” and “Z” in each of which excess or deficiency of the shopping baskets 1 has occurred.

FIG. 9 represents usage of the shopping baskets 1 by the number of unused shopping baskets 1 in each of the stores “X” and “Y” in one day. In the graph shown in FIG. 9, the vertical axis represents the number of unused shopping baskets 1—namely the number of shopping baskets 1 whose results of detection by the detector 11 are “absence of stack”, and the horizontal axis represents time with increments of 1 hour. Also in the graph shown in FIG. 9, “A1” represents the number of unused shopping baskets 1 in the store “X”, while “A2” represents the number of unused shopping baskets 1 in the store “Z”.

In the example of FIG. 9, between 12:00 and 13:00 and between 13:00 and 14:00 in the store “X”, the number of unused shopping baskets 1 is zero, and every shopping basket 1 is used. That is, in the store “X”, there are time periods in which the shopping baskets 1 are insufficient, and opportunity loss that customers 5 can use no shopping basket 1 has occurred. On the other hand, in the store “Z”, even in a time period of the least number of unused shopping baskets 1, about 10 shopping baskets 1 are left, and an event showing excess supply of the shopping baskets 1 has occurred.

In this case, the administrator browses the graph shown in FIG. 9, or information corresponding to the graph shown in FIG. 9, and is thereby able to provide the executives with, for example advice to lend surplus shopping baskets 1 in the store “Z” to the store “X”, etc. The administrator is also able to provide the executive of the store “Z” with, for example advice to improve management so that excess or deficiency of shopping baskets 1 does not occur.

Besides, the administrator browses respective pieces of version information as respective pieces of state information of the shopping baskets 1 in each of the stores 4, or information obtained by processing the respective pieces of version information through the main management system 61, and is thereby able to grasp whether or not respective versions of software or the like are up to date. This case enables the administrator to provide the executives of the stores 4 with, for example, if any of versions of software are not up to date, advice on software update.

Here, in place of provision of the advice, the administrator may perform the content of the advice according to permission obtained from the executive of the store 4. For example, when one or more batteries of the shopping baskets 1 in a certain store 4 are deteriorated, the administrator may dispatch a worker carrying new shopping baskets 1 to the store 4 in order to replace corresponding one or more shopping baskets 1 with one or more new shopping baskets 1. For example, when one or more software versions of the shopping baskets 1 in a certain store 4 are out-of-date, the administrator causes the main management system 61 to communicate with corresponding one or more shopping baskets 1 through the power supply device 2, thereby rendering the one or more software versions of the shopping baskets 1 up to date.

Here, one or more shopping baskets 1 to be replaced may be provided with an activation instruction (activation information) to activate a specific operation according to a specific command as a trigger in advance from the main management system 61 through the power supply device 2. In this case, for example, a worker dispatched to the store 4 in order to replace one or more shopping baskets 1 causes a portable terminal to send out the specific command, and is thereby able to light or drive one or more light emitting devices (LEDs) or speakers in the one or more shopping baskets 1 to be replaced. This case enables the worker to easily find the one or more shopping baskets 1 to be replaced even if many shopping baskets 1 exist in the store 4. Alternatively, not the one or more shopping baskets 1 to be replaced but the power supply device 2 or the selling system 3 may be configured to receive the specific command, thereby performing a process of causing the one or more shopping baskets 1 to light the one or more light emitting devices or the like when the one or more shopping baskets 1 are put on the power supply device 2 or the store device 31.

### (4) Modified Examples

The above embodiment is merely one of various embodiments of the present disclosure. In the above embodiment, various modifications are possible in light of general arrangement and the like as long as an object of the disclosure can be achieved. Functions similar to the information acquisition system 100 may also be embodied by an information acquisition method, a computer program, a non-transitory computer-readable medium, or the like.

An information acquisition method according to an aspect includes acquiring state information from a transport device (shopping basket) 1 through communication with the transport device 1. The transport device 1 allows an article (an item of goods) to be put on or in and is used for transportation of the article in a facility (store) 4. The state information is information on a state of the transport device 1.

A non-transitory computer-readable medium according to an aspect stores a program including instructions which, when executed on a computer system, perform acquiring state information from a transport device (shopping basket) 1 through communication with the transport device 1. The transport device 1 allows an article (an item of goods) to be put on or in and is used for transportation of the article in a facility (store) 4. The state information is information on a state of the transport device 1.

The modified examples of the above embodiment will hereinafter be described. Various modified examples below are applicable by appropriate combination.

The information acquisition system 100 according to the disclosure may include a computer system in, for example, the controller (receiver) 22 or the like. The computer system may be mainly composed of a processor and a memory as hardware. Functions as the information acquisition system 100 according to the disclosure may be realized as a result of the processor executing the program stored in the memory of the computer system. The program may not only be stored in the memory of the computer system but also be provided through a telecommunications network, or be stored in a computer-readable medium such as a memory card, an optical disc, and a hard disk drive. The processor of the computer system may be composed of one or more electronic circuits including a semiconductor integrated circuit (IC) or a large scale integrated (LSI) circuit. The integrated circuit such as IC or LSI stated herein is called differently according to integration, and may include an integrated circuit called system LSI, very large scale integration (VLSI) or ultra large scale integration (ULSI). In addition, a field-programmable gate array (FPGA) to be programmed after production of LSI, or a logic device that allows reconfiguration of connection relationship inside LSI or reconstruction of the circuit partition inside LSI. The electronic circuits may be integrated on one chip, or provided on chips in a distributed manner. The chips may be consolidated into one device, or provided in devices in a distributed manner. The computer system stated herein includes a microcontroller containing one or more processors and one or more memories. The microcontroller may therefore be composed of one or more electronic circuits including a semiconductor integrated circuit or a large scale integrated circuit.

In the above embodiment, the transport device 1 is not limited to the shopping basket 1. Examples thereof may further include: containers such as baskets and tableware used for purposes other than shopping; and carts, trays, dishes, hand trucks and the like, each of which allows one or more articles to be put on or in, thereby holding the one or more articles.

In the above embodiment, functions provided for the power supply device 2 being consolidated into one housing is not essential for the configuration of the power supply device 2. The components of the power supply device 2 may be provided in housings in a distributed manner. For example, the communication unit 21, the receiver 22 and the storage 23 may be provided separately from the internal circuit of the power supply device 2. Moreover, at least a function of part of the power supply device 2 may be realized by, for example, a server system, a cloud (cloud computing) service, or the like.

In the above embodiment, the electric circuit 14 may include the controller 13. Conversely, the reader 141, the display 142, the operating unit 143 and the like may be provided separately from the electric circuit 14.

In the above embodiment, the state information may contain permission information. The “permission information” stated in the disclosure is information representing whether or not use of the shopping basket (transport device) 1 is permitted in one store (facility) 4. For example, when the state information of a certain shopping basket 1 contains permission information on prohibition of use in a store “α”, the shopping basket 1 cannot be used in the store “α”. Specifically, in the store “α”, customers 5 holding the shopping basket 1 in hand cannot cause the reader 141 to read any goods information or perform any checkout process of goods. The permission information may be rewritable through the main management system 61. That is, for example, the administrator (e.g., the service provider of the information acquisition system 100) may cause the main management system 61 to communicate with the shopping basket 1 through the power supply device 2, thereby rendering the permission information of the shopping basket 1 up to date. In this case, for example even when a different store's (4) shopping basket 1 is included due to theft or the like, the administrator is able to take measures such as prohibiting the different store's (4) shopping basket 1 from being used by a remote operation by the main management system 61.

Note that identification information, position information, or area information may be used as the permission information. In this case, it is possible to determine whether or not to permit the use of the shopping basket 1 according to whether or not, for example, the identification information of the shopping basket 1 is contained in a list of an identification information set on shopping baskets 1 registered at the store 4. The list of the identification information set may contain, for example common identification information among stores 4 of the same group. This case enables shopping baskets 1 having the common identification information to be used in the stores 4 of the same group.

The permission information may contain code types readable by the reader 141. In this case, it is possible to take measures such as, for example, permitting readers 141 of shopping baskets 1 in a certain store 4 to read only JAN codes, and permitting readers 141 of shopping baskets 1 in a different store 4 to also read codes other than the JAN codes. Examples of the codes other than the JAN codes include QR codes (Registered trademark), and book JAN codes.

In the first acquisition example of the above embodiment, the power supply device 2 transmits a request signal to each of the shopping baskets 1 at regular intervals, thereby acquiring state information from each of the shopping baskets 1, but the disclosure is not intended to be limited to this. For example, each of the shopping baskets 1 may transmit its own state information to the power supply device 2 at regular intervals. That is, a trigger for acquiring the state information may be generated by the power supply device 2 or by the shopping baskets 1.

In the first acquisition example, each shopping basket 1 may transmit its own state information to the power supply device 2, for example, when charging voltage of its own secondary battery 12 is lower than predetermined voltage, or when the number of charge cycles of its own secondary battery 12 exceeds a predetermined number. In this case, the state information preferably contains warning information representing a replacement request of a corresponding secondary battery 12. Therefore, the administrator (e.g., the store manager of the store 4) browses information (e.g., information obtained by processing state information) through the subsidiary management system 62, and is thereby able to grasp the presence of the shopping basket 1 requiring the replacement of the secondary battery 12.

In the above embodiment, each shopping basket 1 communicates with the power supply device 2 by serial communication, but the disclosure is not intended to be limited to this. For example, each shopping basket 1 may communicate with the power supply device 2 by wireless communication. That is, each shopping basket (transport device) 1 may possess a function configured to provide its own state information by wireless communication.

The subsidiary management system 62 communicate with the communication unit 21 of the power supply device 2, thereby collecting respective pieces of state information on shopping baskets 1 acquired through the receiver 22 of the power supply device 2, but the disclosure is not intended to be limited to this. For example, each of shopping baskets 1 may possess a function configured to communicate with the subsidiary management system 62 by wireless communication, and the subsidiary management system 62 may collect respective pieces of state information from the shopping baskets 1 directly and not through the power supply device 2. That is, each shopping basket (transport device) 1 may possess a function configured to provide its own state information by wireless communication. In this case, the subsidiary management system 62 functions as the communication unit 21 and the receiver 22.

The main management system 61 communicates with the output unit 25 of the power supply device 2, thereby collecting respective pieces of state information of shopping baskets 1 acquired through the receiver 22 of the power supply device 2, but the disclosure is not intended to be limited to this. For example, each of shopping baskets 1 may possess a function configured to communicate with the main management system 61 by wireless communication, and the main management system 61 may correct respective pieces of state information from the shopping baskets 1 directly and not through the power supply device 2. In this case, the shopping baskets 1 function as the output unit 25. Moreover, in this case, the information acquisition system 100 is able to be realized by one or more shopping baskets 1 having their own output unit 25.

In the above embodiment, the subsidiary management system 62 is the server, but the disclosure is not intended to be limited to this. For example, the power supply device 2 or the selling system 3 may include the subsidiary management system 62.

In the above embodiment, the main management system 61 and the subsidiary management system 62 are provided separately from each other, but the disclosure is not intended to be limited to this. For example, the subsidiary management system 62 may be consolidated into the main management system 61. In this case, the output unit 25 may possess a function as the communication unit 21, and the communication unit 21 is unnecessary.

In the above embodiment, the power supply device 2 as the basket storage area 46 is disposed near the entrance 41 of the store 4, but the disclosure is not intended to be limited to this. For example, besides the basket storage area 46 near the entrance 41, the store 4 may be provided with a basket storage area for collection disposed near the register counter 45. That is, the store 4 may be provided with basket storage areas, or power supply devices 2. In this case, any one of the power supply devices 2 may serve as a main device whose receiver 22 is configured to communicate with one or more different power supply devices 2, thereby collecting respective pieces of shopping baskets 1 acquired through the receivers 22 of the one or more different power supply devices 2.

In the above embodiment, the power supply device 2 acquires a history of respective pieces of state information and goods information on the shopping baskets 1, but the disclosure is not intended to be limited to this. For example, the selling system 3 may acquire the history of respective pieces of state information and goods information on the shopping baskets 1. That is, the selling system 3 may be provided with the communication unit 21 and the receiver 22. Also, in the above embodiment, the power supply device 2 acquires a history of respective pieces of state information and goods information on the shopping baskets 1 to provide it to the main management system 61 and/or the subsidiary management system 62, but the disclosure is not intended to be limited to this. For example, the selling system 3 may acquire the history of respective pieces of state information and goods information on the shopping baskets 1 to provide it to the main management system 61 and/or the subsidiary management system 62. That is, the selling system 3 may be provided with the communication unit 21, the receiver 22 and the output unit 25.

As an example, when the selling system 3 (store device 31) performs a checkout process of one or more goods put in each shopping basket 1, the selling system 3 may communicate with each shopping basket 1 to acquire a history of state information and one or more pieces of goods information from each shopping basket 1. Note that the selling system 3 (store device 31) and the power supply device 2 may be provided with the communication unit 21 and the receiver 22, respectively.

In the above embodiment, the power supply device 2 doubles as the stack device, but the disclosure is not intended to be limited to this. For example, besides the power supply device 2, the store (facility) 4 may be provided with a stack device that allows unused shopping baskets (transport devices) to be stacked on.

In the above embodiment, not only a history of one or more goods information (article information) but also state information of each shopping basket 1 may be associated with information (time stamp) on time that they are acquired, and then stored in the storage 144. In this case, the receiver 22 acquires state information of each shopping basket 1 and the information on time that the state information is acquired.

In the above embodiment, the receiver 22 acquires a history of a goods information (article information) set during a period of use, but whether or not to acquire the history of the goods information set is voluntary. That is, the receiver 22 may acquire only state information of each shopping basket 1.

In the above embodiment, the information acquisition system 100 includes the subsidiary management system 62, but the subsidiary management system 62 is not essential. That is, as long as the information acquisition system 100 is configured to acquire at least state information of each shopping basket (transport device) 1, it needn't possess a function of utilizing state information acquired. Even in this case, it is possible for the administrator (e.g., the store manager of the store 4) to take statistics based on respective pieces of state information on shopping baskets 1 acquired through the receiver 22, thereby grasping the situation of the store 4 associated with the respective pieces of state information on the shopping baskets 1.

In the above embodiment, the shopping assistance system 200 may employ not only a style allowing the purchase of goods without help of store clerk, but also a style with store clerk at the register counter like a manned one. Besides, the shopping assistance system 200 may be employed in, for example the store without store clerk.

In the above embodiment, the information acquisition system 100 is employed in order to acquire respective pieces of state information of shopping baskets (transport devices) 1, but the disclosure is not intended to be limited to this. For example, the information acquisition system 100 may be employed in order to acquire one or more pieces of state information on one or more carts (transport devices) 1 each of which allows one or more articles picked in a distribution warehouse to be put in or on. Besides, the information acquisition system 100 may be employed in order to acquire one or more pieces of state information on one or more carts each of which allows one or more articles picked in a factory to be put in, or on one or more trays each of which allows one or more parts to be put on.

(Brief)

As stated above, an information acquisition system (100) according to a first aspect includes a transport device (shopping basket) (1), a communication unit (21) and a receiver (controller) (22). The transport device (1) allows one or more articles (one or more goods) to be put on or in and is used for transportation the one or more articles in a facility (store) 4. The communication unit (21) is configured to communicate with the transport device (1). The receiver (acquisition unit) (22) is configured to acquire state information from the transport device (1) through communication between the communication unit (21) and the transport device (1). The state information is information on a state of the transport device (1).

This aspect enables an administrator to grasp information on the transport device (1).

An information acquisition system (100) according to a second aspect turning on the first aspect includes, as the facility (4), facilities (4). Each of the facilities (4) is provided with the transport device (1). The information acquisition system (100) further includes an output unit (25) configured to provide the state information acquired through the receiver (22) to a main management system (61) configured to manage the facilities (4).

This aspect enables an administrator of the main management system (61) configured to manage the facilities (4) to grasp respective pieces of information on transport devices (1) introduced into the facilities (4).

An information acquisition system (100) according to a third aspect turning on the first aspect includes, as the transport device (1), transport devices (1). The state information of each of the transport devices (1) contains unique identification information assigned to a corresponding transport device (1).

This aspect makes it possible to acquire respective pieces of state information on the transport devices (1) with the transport devices (1) distinguished from each other.

An information acquisition system (100) according to a fourth aspect turning on the second aspect includes, as the transport device (1), transport devices (1). The state information of each of the transport devices (1) contains unique identification information assigned to a corresponding transport device (1).

This aspect makes it possible to acquire respective pieces of state information on the transport devices (1) with the transport devices (1) distinguished from each other.

An information acquisition system (100) according to a fifth aspect turning on any of the first to fourth aspects, the state information further contains usage information representing whether or not the transport device (1) is in use.

This aspect enables an administrator to grasp usage of the transport device (1) introduced into the facility (store) (4).

In an information acquisition system (100) according to a sixth aspect turning on the fifth aspect, the usage information is as follows. That is, the usage information represents whether or not the transport device (1) is out-of-use, according to whether or not the transport device (1) is stacked on a stack device (power supply device) (2) that allows the transport device (1) that is out-of-use to be stacked on.

This aspect enables an administrator to grasp usage of the transport device (1) introduced into the facility (store) (4).

In an information acquisition system (100) according to a seventh aspect turning on any of the first to sixth aspects, the transport device (1) possesses a secondary battery (12) configured to be charged by charging power supplied from a power supply device (2). The state information further contains battery information representing a state of the secondary battery (12).

This aspect enables an administrator to grasp a deterioration condition of the secondary battery (12) of the transport device (1).

In an information acquisition system (100) according to an eighth aspect turning on any of the first to seventh aspects, the stack device (2) allows the transport device (1) that is out-of-use to be stacked on, and is provided with the communication unit (21) and the receiver (22).

This aspect makes it possible to realize the communication unit (21) and the receiver (22) by an existing stack device (2) introduced into the facility (store) (4) for stack of the transport device (1). Here, the stack device (2) may be provided with an output unit (25). This aspect makes it possible to realize the communication unit (21), the receiver (22) and the output unit (25) by the existing stack device (2) introduced into the facility (store) (4) for stack of the transport device (1).

In an information acquisition system (100) according to a ninth aspect turning on any of the first to eighth aspects, the transport device (1) possesses a function configured to output the state information by wireless communication.

This aspect enables the receiver (22) to acquire the state information from the transport device (1) directly and not through a relay.

An information acquisition system (100) according to a tenth aspect turning on any of the first to ninth aspects further includes a subsidiary management system (62) configured to manage information based on the state information acquired through the receiver (22).

This aspect enables an administrator to browse the information managed by the subsidiary management system (62), thereby easily grasping a situation of the facility (4) associated with the state information of the transport device (1).

In an information acquisition system (100) according to an eleventh aspect turning on the second aspect, the state information contains permission information representing whether or not use of the transport device (1) in a corresponding facility (4) is permitted. The permission information is rewritable through the main management system (61).

This aspect enables an administrator to easily manage the transport devices (1) introduced into the facilities (4).

In an information acquisition system (100) according to a twelfth aspect turning on any of the first to eleventh aspects, the receiver (22) is further configured to acquire a history of respective one or more pieces of article information during a period of use of the transport device (1) through the communication between the communication unit (21) and the transport device (1). The article information is information on the one or more articles put on or in the transport device (1).

This aspect enables an administrator to grasp not only the information on a state of the transport device (1) but also the information on the article put on or in the transport device (1).

In an information acquisition system (100) according to a thirteenth aspect turning on the twelfth aspect, the period of use starts at time that the transport device (1) that is out-of-use and stacked on the stack device (2) leaves the stack device. The period of use starts also ends at time that the transport device (1) is returned to the stack device (2) or when the receiver (22) acquires the history.

In this aspect, a history of article information is acquired only for a time period during which the transport device (1) is in use by a user, so that an administrator is able to grasp information on the article associated with user's action.

A management system (main management system) (61) according to a fourteenth aspect is configured to collect state information from an information acquisition system (100) in each of facilities (4), thereby managing the facilities (4). Each of the facilities (4) is provided with, as the information acquisition system (100), the information acquisition system (100) according to the second aspect.

This aspect enables an administrator of the main management system (61) to grasp information on the transport device (1) introduced into each of the facilities (4).

A shopping assistance system (200) according to a fifteenth aspect includes an information acquisition system (100) according to any of the first to thirteenth aspects, and a selling system (3). The selling system (3) is configured to perform a selling process of the one or more articles as one or more goods.

This aspect enables an administrator to grasp information on the transport device (1).

In a shopping assistance system (200) according to a sixteenth aspect turning on the fifteenth aspect, the selling system (3) is provided with the communication unit (21) and the receiver (22).

This aspect makes it possible to realize the communication unit (21) and the receiver (22) by an existing selling system (3) introduced into the store (4) in order to perform checkout of the one or more goods. Here, the selling system (3) may further be provided with an output unit (25). This aspect makes it possible to realize the communication unit (21), the receiver (22) and the output unit (25) by the existing selling system (3) introduced into the store (4) in order to perform checkout of the one or more goods.

An information acquisition method according to a seventeenth aspect includes acquiring state information from a transport device (1) through communication with the transport device (1). The transport device (1) allows one or more articles to be put on or in and is used for transportation of the one or more articles in a facility (4). The state information is information on a state of the transport device (1).

This aspect enables an administrator to grasp information on the transport device (1).

In an information acquisition method according to an eighteenth aspect turning to the seventeenth aspect, as the facility (4), facilities (4) are provided. Each of the facilities (4) is provided with the transport device (1).

The information acquisition method further includes providing the state information acquired through the receiver (22) to a main management system (61) configured to manage the facilities (4).

This aspect enables an administrator of the main management system (61) to grasp respective pieces of information on transport devices (1) introduced into the facilities (4).

A non-transitory computer-readable medium according to a nineteenth aspect stores a program including instructions which, when executed on a computer system, perform acquiring state information from a transport device (1) through communication with the transport device (1). The transport device (1) allows one or more articles to be put on or in and is used for transportation of the one or more articles in a facility (4). The state information is information on a state of the transport device (1).

This aspect enables an administrator to grasp information on the transport device (1).

In a non-transitory computer-readable medium according to a twentieth aspect turning on the nineteenth aspect, as the facility (4), facilities (4) are provided. Each of the facilities (4) is provided with the transport device (1). The instructions perform further providing the state information acquired through the receiver (22) to a main management system (61) configured to manage the facilities (4).

This aspect enables an administrator of the main management system (61) to grasp respective pieces of information on the transport devices (1) introduced into the facilities (4).

Besides the above aspects, various configurations (including the modified examples) of the information acquisition system (100) according to the above embodiment can be embodied by the information acquisition method, a computer program or a storage medium storing the program.

The configurations according to the second to thirteenth aspects can be omitted appropriately and are not essential for the information acquisition system (100). The configuration according to the sixteenth aspect can also be omitted appropriately and is not essential for the shopping assistance system (200). The configuration according to the eighteenth aspect can be omitted appropriately and is not essential for the information acquisition method. The configuration according to the twentieth aspect can be omitted appropriately and is not essential for the non-transitory computer-readable medium.

1. An information acquisition system, comprising
a transport device that allows one or more articles to be put on or in and is used for transportation of the one or more articles in a facility,
a communication unit configured to communicate with the transport device, and
a receiver configured to acquire state information on a state of the transport device from the transport device through communication between the communication unit and the transport device.

2. The information acquisition system of claim 1, comprising, as the facility, facilities, wherein
each of the facilities is provided with the transport device, and
the information acquisition system further comprises an output unit configured to provide the state information acquired through the receiver to a main management system configured to manage the facilities.

3. The information acquisition system of claim 1 comprising, as the transport device, transport devices, wherein
the state information of each of the transport devices contains unique identification information assigned to a corresponding transport device.

4. The information acquisition system of claim 2, comprising, as the transport device, transport devices, wherein
the state information of each of the transport devices contains unique identification information assigned to a corresponding transport device.

5. The information acquisition system of claim 1, wherein the state information further contains usage information representing whether or not the transport device is in use.

6. The information acquisition system of claim 5, wherein the usage information represents whether or not the transport device is out-of-use, according to whether or not the transport device is stacked on a stack device that allows the transport device that is out-of-use to be stacked on.

7. The information acquisition system of claim 1, wherein
the transport device includes a secondary battery configured to be charged by charging power supplied from a power supply device, and
the state information further contains battery information representing a state of the secondary battery.

8. The information acquisition system of claim 1, wherein the stack device allows the transport device that is out-of-use to be stacked on, and is provided with the communication unit and the receiver.

9. The information acquisition system of claim 1, wherein the transport device includes a function configured to output the state information by wireless communication.

10. The information acquisition system of claim 1, further comprising a subsidiary management system configured to manage information based on the state information acquired through the receiver.

11. The information acquisition system of claim 2, wherein
the state information contains permission information representing whether or not use of the transport device in a corresponding facility is permitted, and
the permission information is rewritable through the main management system.

12. The information acquisition system of claim 1, wherein the receiver is further configured to acquire a history of respective one or more pieces of article information on the one or more articles put on or in the transport device during a period of use of the transport device through the communication between the communication unit and the transport device.

13. The information acquisition system of claim 12, wherein the period of use starts at time that the transport device that is out-of-use and stacked on the stack device leaves the stack device, and ends at time that the transport device is returned to the stack device or when the receiver acquires the history.

14. A management system, configured so that each of facilities is provided with the information acquisition system of claim 2, wherein the management system is configured to collect state information from the information acquisition system in each of the facilities, thereby managing the facilities.

15. A shopping assistance system, comprising
the information acquisition system of claim 1, and
a selling system configured to perform a selling process of the one or more articles as one or more goods.

16. The shopping assistance system of claim 15, wherein the selling system is provided with the communication unit and the receiver.

17. An information acquisition method, comprising acquiring state information on a state of a transport device, which allows one or more articles to be put on or in and is used for transportation of the one or more articles in a facility, from the transport device through communication with the transport device.

18. The information acquisition method of claim 17, wherein
as the facility, facilities are provided,
each of the facilities is provided with the transport device,
the information acquisition method further comprises providing the state information acquired through the receiver to a main management system configured to manage the facilities.

19. A non-transitory computer-readable medium, storing a program comprising instructions which, when executed on a computer system, perform acquiring state information on a state of the transport device, which allows one or more articles to be put on or in and is used for transportation of the one or more articles in a facility, from the transport device through communication with the transport device.

20. The non-transitory computer-readable medium of claim 19, wherein
as the facility, facilities are provided,
each of the facilities is provided with the transport device, and
the instructions perform further providing the state information acquired through the receiver to a main management system configured to manage the facilities.
